(19) United States
(12) Patent Application Publication
(10) Pub. No.: US 2025/0367866 A1
(43) Pub. Date: Dec. 4, 2025

(54) INJECTION MOLD DEVICE

(71) Applicant: National Kaohsiung University of Science and Technology, Kaohsiung (TW)

(72) Inventor: Jui-Hung CHENG, Kaohsiung City (TW)

(21) Appl. No.: 18/809,708

(22) Filed: Aug. 20, 2024

(30) Foreign Application Priority Data
Jun. 3, 2024 (TW) 113120462

(51) Int. Cl. B29C 45/73; B29C 45/00; B29C 45/77; B29C 45/78

(52) U.S. Cl. CPC B29C 45/73; B29C 45/77; B29C 45/78; B29C 2045/0075

(57) ABSTRACT

An injection mold device includes a main body unit, a mold unit, a feeding unit, and a control unit. The main body unit includes a base seat, a frame, an elevating seat, a fixing seat, an installing seat, and a top plate. The mold unit includes an electric cylinder, a lower mold, and an upper mold. The electric cylinder is operable for driving the lower mold to move relative to the upper mold. The feeding unit includes a feeding pipeline, a peristaltic pump operable for squeezing the feeding pipeline, and an injection mechanism having a material collection barrel, a piston, an injection pipeline, and a servo cylinder that is operable for driving the piston to move upwardly and downwardly. The control unit includes a surveillance module signally connected to and operable for controlling the electric cylinder, the peristaltic pump, and the servo cylinder.

### CROSS-REFERENCE TO RELATED APPLICATION

This application claims priority to Taiwanese Invention Patent Application No. 113120462, filed on Jun. 3, 2024, the entire disclosure of which is incorporated by reference herein.

### FIELD

The disclosure relates to an injection mold device, and more particularly to an injection mold device for liquid silicone rubber (LSR) injection molding or two-color injection molding.

### BACKGROUND

Liquid silicone rubber (LSR) is a nontoxic material having good transparency, and is widely applied in optical and medical products, and recently, in industrial and technological products. LSR is processed through injection molding, and an injection molding process in which a conventional injection molding machine is used is as follows. First, two raw materials in the liquid state are mixed and then disposed into an injection device; then, the injection device feeds the material mixture into a mold. After a cavity of the mold is filled completely with the material mixture, the material mixture is cured by heat. However, the injection device of the conventional injection molding machine has a horizontal configuration. Furthermore, the conventional injection molding machine has a reciprocating screw mechanism that moves the LSR through the injection device, that requires the injection device to be horizontally placed, and that needs a big horizontal processing space. Hence, the conventional injection molding machine can only be placed inside a factory and takes up a lot of space, and is not accessible to people that are not factory workers.

### SUMMARY

Therefore, an object of the disclosure is to provide an injection mold device that can alleviate at least one of the drawbacks of the prior art.

According to the disclosure, the injection mold device includes a main body unit, a mold unit, a feeding unit, and a control unit. The main body unit includes a base seat, a frame mounted on the base seat, an elevating seat, a fixing seat, an installing seat, and a top plate. The elevating seat is disposed on the frame and movable upwardly and downwardly along the frame. The fixing seat is fixed to the frame and disposed above the elevating seat. The installing seat is fixed to the frame and disposed above the fixing seat. The top plate is fixed to the frame and disposed above the installing seat. The mold unit includes an electric cylinder, a lower mold, and an upper mold. The electric cylinder is disposed on the base seat and connected to a bottom surface of the elevating seat. The lower mold is disposed on a top surface of the elevating seat. The upper mold is disposed on a bottom surface of the fixing seat and is aligned with a position of the lower mold. The electric cylinder is operable for driving the elevating seat to move upwardly and downwardly, thereby driving the lower mold to move relative to the upper mold. The feeding unit includes a feeding pipeline, a peristaltic pump, and an injection mechanism. The peristaltic pump is operable for squeezing the feeding pipeline. The injection mechanism is mounted to the main body unit, and has a material collection barrel, a piston, an injection pipeline, and a servo cylinder. The material collection barrel is disposed on the installing seat and is connected to the feeding pipeline. The piston is disposed in the material collection barrel and is upwardly and downwardly movable. The injection pipeline is connected to the material collection barrel and one of the upper mold and the lower mold. The servo cylinder is operable for driving the piston to move upwardly and downwardly. The control unit includes a surveillance module that is signally connected to and operable for controlling the electric cylinder, the peristaltic pump, and the servo cylinder.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic view illustrating an embodiment of an injection mold device according to the disclosure.

FIG. 2 is a schematic view illustrating a control unit of the embodiment.

FIG. 3 is a schematic view illustrating the embodiment during an injection mold process.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

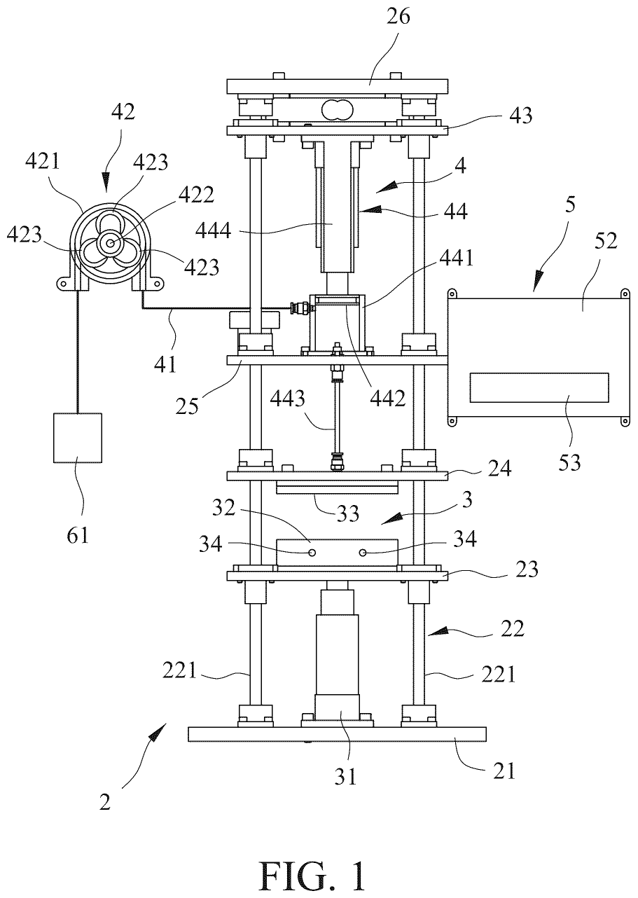

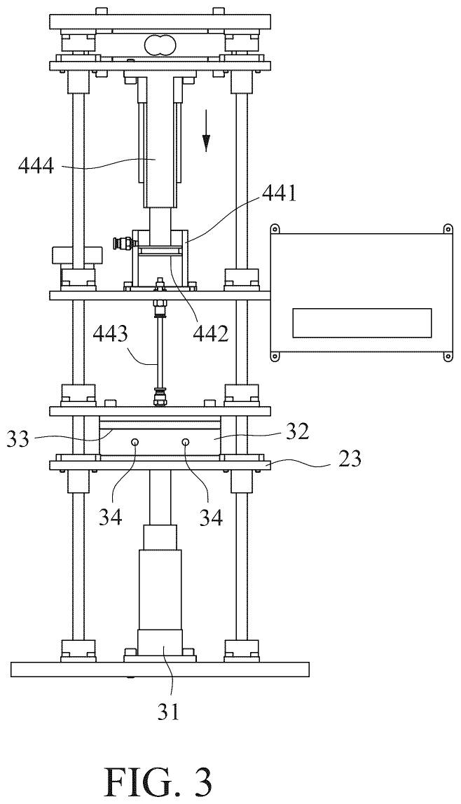

Referring to FIGS. 1 to 3, an embodiment of an injection mold device according to the disclosure includes a main body unit 2, a mold unit 3 disposed on the main body unit 2, a feeding unit 4 disposed on the main body unit 2, and a control unit 5. The main body unit 2 includes a base seat 21, a frame 22 mounted on the base seat 21, an elevating seat 23 disposed on the frame 22, and movable upwardly and downwardly along the frame 22, a fixing seat 24 fixed to the frame 22 and disposed above the elevating seat 23, an installing seat 25 fixed to the frame 22 and disposed above the fixing seat 24, and a top plate 26 fixed to the frame 22 and disposed above the installing seat 25. The frame 22 includes a plurality of columns 221 that extend from the base seat 21 and through the elevating seat 23, the fixing seat 24, and the installing seat 25, and that are connected to the top plate 26. In other embodiments, the configuration of the frame 22 may be different.

The mold unit 3 includes an electric cylinder 31 disposed on the base seat 21 and connected to a bottom surface of the elevating seat 23, a lower mold 32 disposed on a top surface of the elevating seat 23, an upper mold 33 disposed on a bottom surface of the fixing seat 24 and aligned with a position of the lower mold 32, and at least one forming member 34 disposed in the lower mold 32. The electric cylinder 31 is operable for driving the elevating seat 23 to move upwardly and downwardly, thereby driving the lower mold 32 to move relative to the upper mold 33. In this embodiment, a number of the at least one forming member 34 is two, and each of the forming members 34 is configured as a heater. Each of the forming members 34 may be an electric heating rod that warms up when provided with electricity. Alternatively, the number of the at least one forming member 34 may be one, and the forming member 34 may be configured as an electric heating plate that abuts against the lower mold 32. In other embodiments, each of the forming members 34 may be configured as an ultraviolet (UV) curer. In other embodiments, the forming members 34 may be disposed in the upper mold 33.

The feeding unit 4 includes a feeding pipeline 41 that is adapted to be connected to a material cartridge 61, a peristaltic pump 42 that is operable for squeezing the feeding pipeline 41, a pressure sensor plate 43 that is fixed to the frame 22 and that is disposed below the top plate 26, and an injection mechanism 44 that is mounted to the main body unit 2. The peristaltic pump 42 may be disposed on the top plate 26, the installing seat 25, or the fixing seat 24 (for the sake of easier explanation, the peristaltic pump 42 is separated from the main body unit 2 in FIG. 1). It should be noted that the peristaltic pump 42 may be disposed at other positions in other embodiments. The peristaltic pump 42 includes a shell body 421 through which the feeding pipeline 41 extends, a rotor 422 that is pivotably disposed in the shell body 421, and a plurality of rollers 423 that outwardly extend from the rotor 422. When the rotor 422 rotates, the rollers 423 intermittently push the feeding pipeline 41 in the shell body 421, thereby intermittently pushing a liquid material in the feeding pipeline 41.

The injection mechanism 44 has a material collection barrel 441 that is disposed on the installing seat 25 and that is connected to the feeding pipeline 41, a piston 442 that is disposed in the material collection barrel 441 and that is upwardly and downwardly movable, an injection pipeline 443 that is connected to the material collection barrel 441 and one of the upper mold 33 and the lower mold 32 (in this embodiment, the injection pipeline 443 is connected to the material collection barrel 441 and the upper mold 33), and a servo cylinder 444 that is mounted to the pressure sensor plate 43 and that is operable for driving the piston 442 to move upwardly and downwardly. In this embodiment, the injection pipeline 443 extends downwardly from the installing seat 25 to the fixing seat 24, and has an end portion extending through the installing seat 25, and another end portion extending through the fixing seat 24. The pressure sensor plate 43 is operable for sensing a reactive force of the servo cylinder 444 to calculate a reactive force that is generated when the piston 442 pushes the liquid material in the material collection barrel 441, and that is then used to calculate a pushing force of the piston 442.

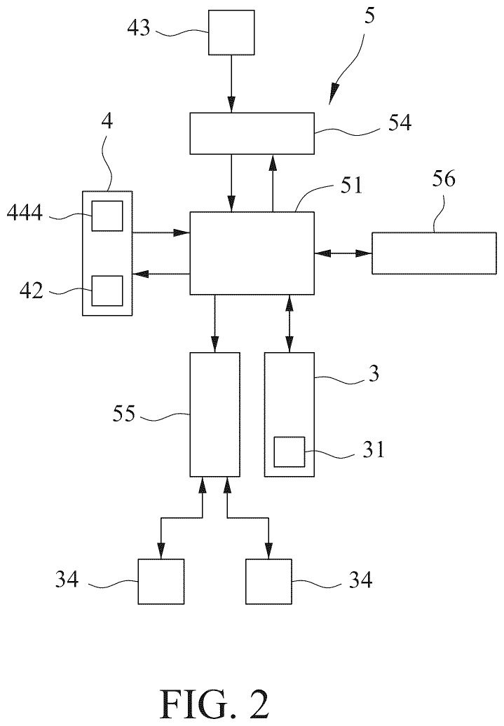

Referring to FIGS. 1 and 2, the control unit 5 includes a surveillance module 51 that is signally connected to and operable for controlling the electric cylinder 31, the peristaltic pump 42, and the servo cylinder 444, a display 52 that is signally connected to the surveillance module 51, a human machine interface 53 that is operable for receiving an input signal and transmitting a controlling signal to the surveillance module 51, a pressure sensor module 54 that is signally connected to the surveillance module 51, and that is operable for receiving a result signal from the pressure sensor module 54, a temperature control module 55 that is electrically connected to the forming members 34 and that is signally connected to the surveillance module 51, and a communicating module 56 that is signally connected to the surveillance module 51.

The surveillance module 51 receives signals to monitor and control operational states of the electric cylinder 31, the peristaltic pump 42, and the servo cylinder 444. The surveillance module 51 is operable for adjusting an output of the electric cylinder 31 in accordance to the result signal to control a locking pressure between the upper mold 33 and the lower mold 32, and to adjust an output of the servo cylinder 444 in order to control the pushing force of the piston 442. Furthermore, the surveillance module 51 is operable for controlling temperature of the forming members 34, i.e., the heaters, via the temperature control module 55, or in some embodiments where the forming members 34 are UV curers, the surveillance module 51 is operable for directly controlling an input and an output of each of the UV curers. The display 52 is configured as a screen that may be fixed to the installing seat 25 or the fixing seat 24, or other positions on the main body unit 2. In other embodiments, the display 52 may be configured as a screen of a mobile device that is signally connected to the surveillance module 51 via a wireless signal or a network signal. The display 52 is operable for displaying an operating interface of the surveillance module 51, information received from different parts of the injection mold device, and operational states of the aforementioned different parts of the injection mold device. Similarly, the human machine interface 53 may be disposed on the main body unit 2, or may be configured as a virtual part of the display 52 that may be accessed through a touchscreen, or configured as a physical part of the display 52; alternatively, the human machine interface 53 may be configured as a mobile device that is signally connected to the surveillance module 51. The human machine interface 53 may be operated by a user to control the surveillance module 51 or to set conditional control rules.

The communicating module 56 uploads signals received from the surveillance module 51 to a cloud server, an Internet of Things (IoT), or a local area network (LAN), receives signals from the cloud server, the IoT, or the LAN (the LAN including Wi-Fi or MQ Telemetry Transport (MQTT)), and transmits the signals to the surveillance module 51. To create a server message block (SMB), a plurality of injection mold devices are simultaneously and signally connected to each other through the LAN, and the SMB allows the injection mold devices to operate in a cooperative manner, thereby creating an automated production line. Uploading information to the cloud server facilitates surveillance, tracking and recording of a manufacturing process of the injection mold devices, and a manufacturing execution system (MES) may be constructed through the information. Furthermore, such information circulation is advantageous for introducing management methods, such as the Plan-Do-Check-Act (PDCA) method, or for introducing smart manufacturing to a manufacturing process of the injection mold device.

Referring to FIGS. 1 to 3, a manufacturing process is as follows. Two liquid raw materials are mixed together to form an LSR mixture. The material cartridge 61 is filled with the LSR mixture (or with another mixture made of two different liquid raw materials), and then is connected to the feeding pipeline 41. The peristaltic pump 42 draws the LSR mixture into the material collection barrel 441 via the feeding pipeline 41, and the electric cylinder 31 drives the elevating seat 23 to move upwardly, so that the lower mold 32 is moved towards the upper mold 33 until the lower and upper molds 32, 33 are clamped together, and the pressure between the upper and lower molds 33, 32 is controlled by the surveillance module 51. The servo cylinder 444 then drives the piston 442 to move downwardly to push the LSR mixture into a mold cavity between the upper and lower molds 33, 32 via the injection pipeline 443 (the pushing force being controlled by the surveillance module 51). Then, the LSR mixture is cured via heat from the heaters (i.e., the forming members 34), thereby forming a product as needed. When the forming members 34 are configured as UV curers, the LSR mixture will be cured via exposure to the UV curers. The feeding unit 4 may be maintained at room temperature when injecting the LSR mixture, which may lower the difficulty of the overall control of the injection mold device, and decrease the number of components needed.

It should be noted that the injection mold device is applicable to other materials for double injection molding, as long as the forming members 34 are disposed at appropriate locations that are effective for curing the LSR mixture.

In conclusion, since the components of the injection mold device are disposed on the main body unit 2, the injection mold device may have a vertical configuration, and the height of the components may be adjusted so that the space that the injection mold device takes up may be minimalized. Furthermore, the electric cylinder 31, the peristaltic pump 42, and the servo cylinder 444 are electrically actuated, and are automatically controlled by the surveillance module 51 to improve accuracy of the control. The communication function of the communicating module 56 is advantageous for automatic manufacturing and smart manufacturing, and for conducting other types of automated management. Hence, the objective of the disclosure is achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An injection mold device comprising:
a main body unit that includes
a base seat,
a frame mounted on said base seat,
an elevating seat disposed on said frame, and movable upwardly and downwardly along said frame,
a fixing seat fixed to said frame and disposed above said elevating seat,
an installing seat fixed to said frame and disposed above said fixing seat, and
a top plate fixed to said frame and disposed above said installing seat;
a mold unit that includes
an electric cylinder disposed on said base seat and connected to a bottom surface of said elevating seat,
a lower mold disposed on a top surface of said elevating seat, and
an upper mold disposed on a bottom surface of said fixing seat and aligned with a position of said lower mold, said electric cylinder being operable for driving said elevating seat to move upwardly and downwardly, thereby driving said lower mold to move relative to said upper mold;
a feeding unit that includes
a feeding pipeline,
a peristaltic pump operable for squeezing said feeding pipeline, and
an injection mechanism mounted to said main body unit, said injection mechanism having a material collection barrel that is disposed on said installing seat and that is connected to said feeding pipeline, a piston that is disposed in said material collection barrel and that is upwardly and downwardly movable, an injection pipeline that is connected to said material collection barrel and one of said upper mold and said lower mold, and a servo cylinder that is operable for driving said piston to move upwardly and downwardly; and
a control unit that includes a surveillance module signally connected to and operable for controlling said electric cylinder, said peristaltic pump, and said servo cylinder.

2. The injection mold device as claimed in claim 1, wherein:
said mold unit further includes at least one forming member that is disposed in at least one of said upper mold and said lower mold;
said at least one forming member is configured as at least one heater; and
said control unit further includes a temperature control module that is electrically connected to said at least one forming member and that is signally connected to said surveillance module, said surveillance module being operable for controlling temperature of said at least one forming member via said temperature control module.

3. The injection mold device as claimed in claim 1, wherein said mold unit further includes at least one forming member that is disposed in at least one of said upper mold and said lower mold, and that is configured as at least one ultraviolet (UV) curer.

4. The injection mold device as claimed in claim 1, wherein said feeding unit further includes a pressure sensor plate that is fixed to said frame and that is disposed below said top plate, said servo cylinder being mounted to said pressure sensor plate, said pressure sensor plate being operable for sensing a reactive force of said servo cylinder to calculate a pushing force of said piston.

5. The injection mold device as claimed in claim 4, wherein said control unit further includes a pressure sensor module that is signally connected to said surveillance module, and that is operable for receiving a result signal from said pressure sensor module, said surveillance module being operable for adjusting an output of said electric cylinder in accordance to said result signal to control a locking pressure between said upper mold and said lower mold, and to adjust an output of said servo cylinder in order to control said pushing force of said piston.

6. The injection mold device as claimed in claim 1, wherein said control unit further includes a communicating module that is signally connected to said surveillance module, that uploads signals received from said surveillance module to a cloud server, an Internet of Things (IoT), or a local area network (LAN), that receives signals from the cloud server, the IoT, or the LAN, and that transmits the signals to said surveillance module.

7. The injection mold device as claimed in claim 1, wherein said control unit further includes a display that is signally connected to said surveillance module, and a human machine interface that is operable for receiving an input signal and transmitting a controlling signal to said surveillance module.
